(19) United States
(12) Patent Application Publication
(10) Pub. No.: US 2018/0192386 A1
(43) Pub. Date: Jul. 5, 2018

(54) Autonomous Timing Adjustment In A Communication Network

(71) Applicant: Alcatel-Lucent USA Inc., Murray Hill, NJ (US)

(72) Inventor: Ashok N. Rudrapatna, Basking Ridge, NJ (US)

(73) Assignee: Alcatel-Lucent USA Inc., Murray Hill, NJ (US)

(21) Appl. No.: 15/394,406

(22) Filed: Dec. 29, 2016

(51) Int. Cl. H04W 56/00; H04W 72/04; H04L 12/26; H04W 72/08

(52) U.S. Cl. CPC H04W 56/0005; H04W 72/0446; H04W 72/082; H04L 43/0858; H04W 56/0045

(57) ABSTRACT

A method and apparatus for timing adjustment in a communication network. In a mobile network, one or more mobile stations (UEs) communication with a common base station (BS) for access to a core network. To align multiple uplink signals and reduce interference, a reference OTL is broadcast from the BS and received at the one or more UEs, the ROTL representing a real or theoretical maximum OTL (one-way trip latency). A universal time reference is then broadcast, often with other data, from the BS and is received by the one or more UEs. Each UE, if it is able, calculates its own OTL and uses that to calculate an δOTL representing an uplink transmission delay. In some cases, an δOTL′ may be calculated representing an uplink transmission delay that takes into account motion of the UE, if any. In some implementations, timing adjustments may be calculated by the BS and sent to individual UEs if necessary.

### BACKGROUND

### Field of the Disclosure

The present disclosure relates generally to network communication and, more particularly, to an apparatus and method for facilitating autonomous timing adjustment in a communication network using a time reference.

### Description of the Related Art

The following abbreviations are herewith expanded, at least some of which are referred to within the following description.

AGP Above Ground Platform

BS Base Station

DL DownLink

GEO Geosynchronous Earth Orbit

GPS Global Positioning System

ICI Inter-Carrier Interference

ISI Inter-Symbol Interference

LEO Low Earth Orbit

OTL One-way Trip Latency

ROTL Reference OTL

RTL Round-Trip Latency

TA Timing Advance/Adjustment

UE User Equipment

UL UpLink

UTR Universal Time Reference

UTC Coordinated Universal Time

In some communication networks, a number of devices communicate wirelessly with a base station or equivalent network node. There are typically many such base stations, each communicating with devices in their coverage area. One example is often referred to as a cellular telephone (or cell phone) network. The devices communicating with the base station are often called cell phones, mobile phones, or smart phones. Other devices may also communicate with the base station, for example monitoring or tracking devices that use the network for reporting information and receiving updates. For convenience herein all such devices will be referred to as UE (user equipment).

When more than one wireless device communicates with the base station, it is helpful to have their signals aligned so that they arrive at the base station at the same or nearly the same time. This minimizes degradation due to, for example, ISI (inter-symbol interference) or ICI (inter-carrier interference). This often requires that UEs with data to transmit must time their transmissions according to a timing adjustment. Presently, the base station typically calculates these timing adjustments and sends them individually to each UE.

Unfortunately, this may be inefficient use of the networks bandwidth resources. Accordingly, there has been and still is a need to address how best to accomplish the related objectives.

Note that the techniques or schemes described herein as existing, possible, or desirable are presented as background for the present invention, but no admission is made thereby that these techniques and schemes or the need for them were heretofore commercialized or known to others besides the inventors.

### SUMMARY OF EMBODIMENTS

The following presents a summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one aspect, a method for timing adjustment for a wireless communication network includes receiving in an UE (user equipment) an ROTL (reference one-way trip latency), receiving in the UE an UTR (universal time reference), calculating by the UE an OTL (one-way trip latency), and calculating by the UE a transmission time adjustment. The method may also include sending a transmission from the UE delayed by the calculated transmission time adjustment. Usually though not necessarily the ROTL and the UTR are received from a base station of the communication network.

In some embodiments, the UE sends a common time availability status notification, for example to a base station. In this case the UE may then receive a transmission time adjustment and send a transmission from the UE delayed by the received transmission time adjustment.

In some embodiments, the UE may maintain a record of calculated OTL values and estimate a rate of change of OTL as a function of a plurality of OTL values. If so the US may calculate a motion-compensated transmission time adjustment.

In some embodiments, the method may also include determining an ROTL, for example by a base station. The ROTL may be broadcast, unicast, or multicast. The ROTL may be determined, for example, by selecting the maximum OTL for any UE currently within range of the base station. In this case the method may also include sending a calculated OTL from the UE and receiving it in the base station. In some embodiments, the method also includes broadcasting a universal time reference, for example from the base station.

In some embodiments, the method also includes receiving at a base station of the communication network a notification that a UE does not have access to a common time value, calculating by the base station a timing adjustment value for the UE, and transmitting the time adjustment value.

In another aspect, a UE includes a processor, a memory device accessible to the processor, an OTL calculator configured to calculate an OTL for the UE, and a transmission time adjustment calculator configured to calculate a timing adjustment as a function of a received UTR, a received ROTL, and the calculated OTL. The UE may also include an OTL value table for recording calculated OTL values and a rate of change estimator configured to estimate a rate of OTL change for the UE. In some embodiments, the UE may also include a motion-compensated transmission time adjustment calculator configured to calculate a motion-compensated transmission time adjustment as a function of the timing adjustment and the estimated rate of OTL change.

In yet another aspect, a UE includes a processor and a memory device. In this aspect the memory device includes program instructions that when executed by the processor cause the UE to calculate an OTL (one-way trip latency), and calculate a transmission time adjustment.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram illustrating selected components of a communication network in which embodiments of the present invention may be implemented.

FIG. 2 is a block diagram illustrating selected components of another communication network in which embodiments of the present invention may be implemented.

FIG. 3 is a message flow diagram illustrating a method according to some embodiments.

FIG. 4 is flow diagram illustrating a method according some embodiments.

FIG. 5 is a block diagram illustrating selected components of a UE according to some embodiments.

### DETAILED DESCRIPTION

In a mobile communication network, a mobile device and a base station are configured to perform uplink-transmission timing adjustment according to a novel scheme as described herein.

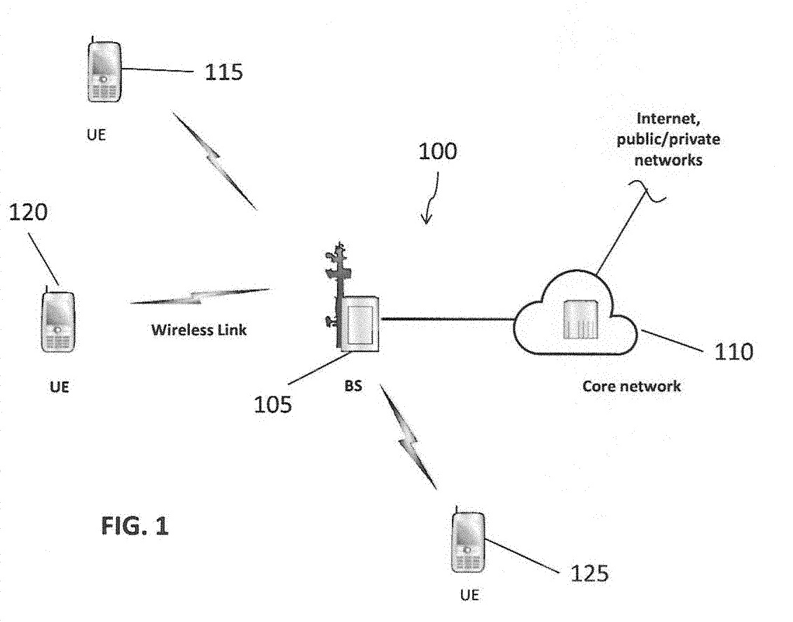

FIG. 1 is a block diagram illustrating selected components of a communication network 100 in which embodiments of the present invention may be advantageously implemented. In this embodiment, each mobile device, or UE (user equipment) communicates over a wireless link with a BS (base station) 105. In FIG. 1, UEs 115 and 125 are shown, each of which may be at varied, and varying, distances from BS 105. A base station typically communicates with wireless devices within its coverage area, sometimes referred to as a cell. There may be a great many UEs communicating through a BS at any given time.

Although only BS 105 is shown, a mobile network often has a great many distributed over a network coverage area. When a UE leaves the coverage area of one BS, communications with it are handed over to another. BS coverage areas often overlap such that the handover from one BS to another may be done without perceptibly interrupting ongoing communications.

In the embodiment of FIG. 1, BS 105 is connected to core network 110, usually by a cable or other high volume transmission medium. Though core network 110, UEs are placed in communication with each other, with UEs in other cells, and other public or private networks such as the Internet.

As alluded to above, communicating with multiple UEs at varying distances poses a challenge for the BS receiver. Independently sent uplink transmissions are frequently misaligned, which contributes to ICI and ISI that may significantly degrade performance. To correct for this, the BS 105 may make a distance determination for each UE in its coverage area and transmit TAs (timing adjustments). The TA for each UE causes the UE to properly time its uplink transmissions for proper alignment with other UEs in the coverage area. TAs must be sent frequently due to UE mobility.

The constant transmission of TAs consumes a significant amount of bandwidth and is inefficient considering that some UEs do not move or move only infrequently while in the BS coverage area. In an effort to provide a more efficient alignment scheme, the BS 105 and UEs 115, 120, 125 of FIG. 1 are reconfigured as described below.

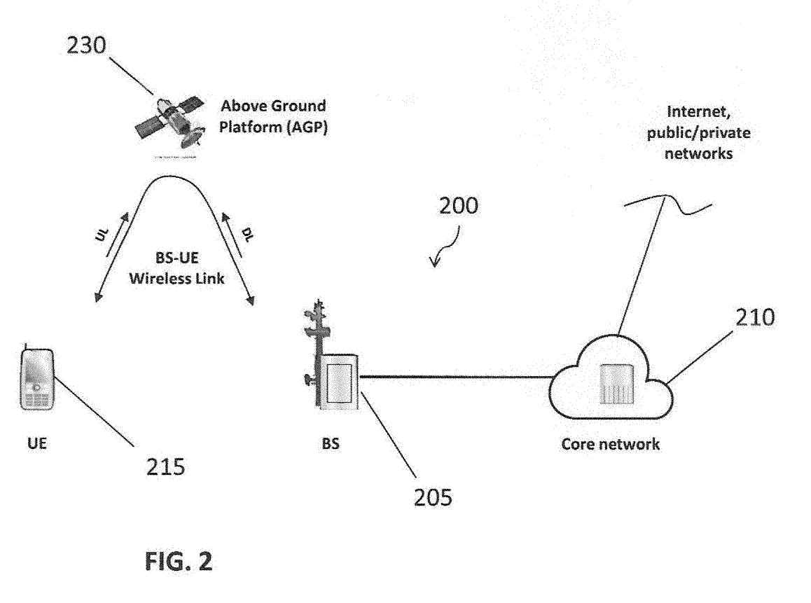

FIG. 2 is a block diagram illustrating selected components of communication network 200 in which embodiments of the present invention may likewise be advantageously implemented. In FIG. 2, UE 215 communicates with BS 205 and core network 210 over a wireless link. In this embodiment, however, the wireless link includes transmission to an AGP (above ground platform), for example LEO (low-earth orbit) satellite 230. Uplink and downlink transmissions between UE 215 and BS 205 are relayed by rapidly moving LEO satellite 230. Note that even though only UE 215 is the only UE shown in FIG. 2, there may be many others. In this scenario, accurate timing alignment may be even more difficult to attain than with the terrestrial network of FIG. 1. The apparatus and methods described herein may also be implemented in the network 200 of FIG. 2.

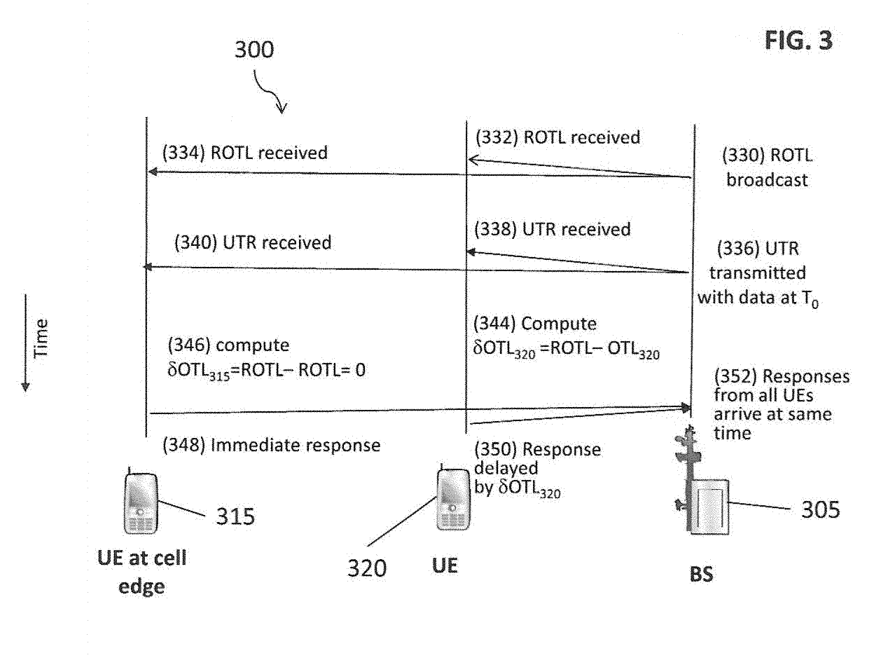

FIG. 3 is a message flow diagram illustrating a method 300 according to some embodiments. In the embodiment of FIG. 3, BS 305 broadcasts (step 330) an ROTL (reference one-way latency), which is received at UE 320 (step 332) and UE 315 (step 334). Each UE stores the received ROTL value for future use, updating its stored value if updates are received. Note that the current ROTL is the same for each UE being served by BS 305, although it is subject to change. The determination of ROTL will now be described.

As used herein, OTL is the one-way trip latency of communications from a BS (or similar node) to a UE (or any other device). In terms of a BS transmission and UE response, OTL represents the time from generation and transmission by the BS to the time a response reaches an implementation independent point in the UE, for example a transmit antenna connector or antenna connector. OTL therefore includes the reception of the BS transmission and generation of a response at the UE. (Strictly speaking, it also includes the time from generation of the original message at the BS to its actual transmission; this distinction may be disregarded in many embodiments.)

For a given BS such as BS 305 shown in FIG. 3, the ROTL may be the maximum OLT of the UEs the BS is currently serving or an estimated maximum for the BS coverage area. In some implementations, the BS will receive from each UE being served of the OTL associated with that UE, in which case the ROTL may simply be set at the highest OTL value. In this case the ROTL may have to be reset if, for example, reports from more distant UEs are received. An ROTL may also be estimated for the known size or extent of the BS coverage area. In either case, a safety factor or marginal additional duration may be added in an attempt to ensure no served UE experiences an OTL greater than the ROTL. The ROTL may simply be imposed by a network manager or other entity.

It is preferred in most implementations that the ROTL will be broadcast only infrequently to account for changes in the ROTL but to inform UEs new to the BS service area. Alternately, new UEs could be informed individually or by multicast as they are acquired.

In the embodiment of FIG. 3, the BS 305 transmits (step 336) a UTR (universal time reference) at a time T₀. The UTR is received at UE 320 (step 338) and at UE 315 (at step 340). Note that in this embodiment, UE 320 is closer to BS 305 than is UE 315, meaning that step 338 occurs before step 340.

The broadcast UTR is made to a commonly available time system, for example UTC (universal coordinated time), which the UE is also presumed to have knowledge of. Other common time systems that could be used may include GPS (global positioning system) timing or a frame counter that can be mapped to a universal time. In some embodiments, a common current time may be transported through the wireless network itself. In any case, each UE receives the UTR at a time T_{1-UE}, which is T₀ plus the transmission time to that particular UE.

Each UE then calculates a OTL time, representing the amount of time in this embodiment that any transmissions from that UE will be delayed in response to an invitation to transmit from the BS. In FIG. 3, δOTL₃₂₀ is calculated at step 344 and δOTL₃₁₅ is calculated at step 346. The δOTL for a UE is the difference between the ROTL and the OTL associated with that UE; δOTL_{UE}=ROTL−OTL_{UE} . . . . The delay time for one UE will of course often be different from that for another UE.

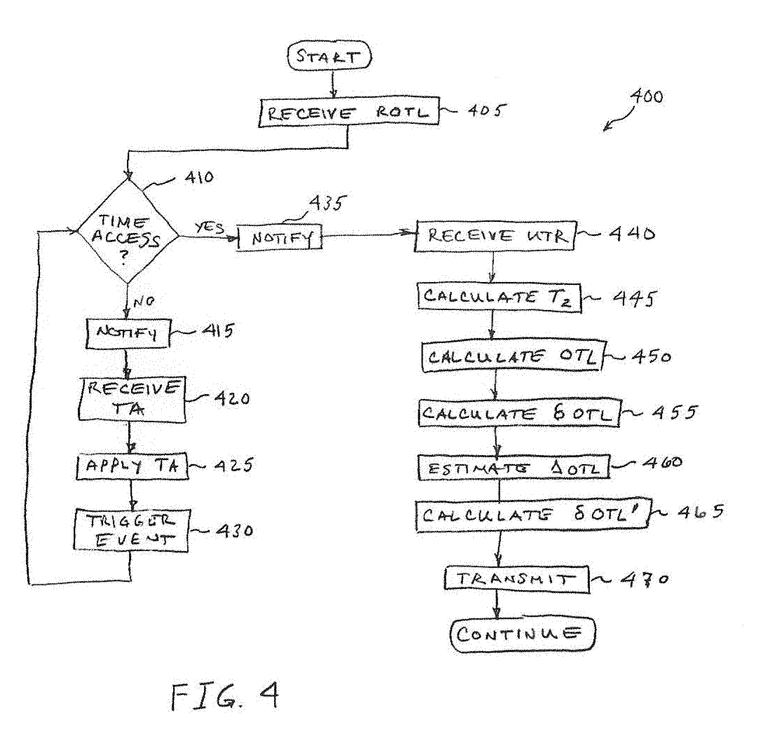

In the embodiment of FIG. 3, UE 315 is positioned at the edge of the cell, or BS coverage area. (Or, alternately, it is the UE in the coverage area with the largest OTL.) For this reason, the δOTL₃₁₅ associated with UE 315 is zero and it responds immediately, that is, with no delay to the BS 305 (step 348). UE 320, on the other hand, delays its response by δOTL₃₂₀. In this embodiment it is expected that the responses aligned and arrive at the BS 305 at the same time (step 352). Note, however, that no level of performance (for example, alignment) is required unless explicated recited in a particular embodiment. In some implementations, some deviation is expected due, for example, to the motion of the UEs or path changes. A manner of mitigating these effects will now be described in reference to FIG. 4.

FIG. 4 is flow diagram illustrating a method 400 according some embodiments. At START, it is presumed that a UE has been configured to operate at least according to this embodiment. The process then begins when a UE receives a transmission containing a ROTL from a network node (step 405), for example a BS. The ROTL of course applies only to communications to the device from which it is received. The UE may receive ROTLs from other network nodes and will handle them in similar fashion as necessary, although for convenience this is not illustrated in FIG. 4.

In the embodiment of FIG. 4, the UE determines (step 410) whether it has access to the current (common) time. It may, for example, currently be in a location where no GPS signal or any other time service is available. If this is the case, the UE sends a notification to the base station (step 415), with the expectation that it will receive a TA (step 420) sent from the BS according to the controlling protocol. It then applies the TA (step 425) to future transmissions.

Again, it has been presumed that the UE has been configured to operate according to this embodiment, so it may at some point begin to calculate its own δOTL if it becomes able to do so even though it cannot do so at a particular time. In the embodiment of FIG. 4, the occurrence of a triggering event (step 430) causes the UE to return to step 410 and determine whether current time is now available. A triggering event may be, for example, the expiration of a timer set at a previous determination or the receipt of a UTR or ROTL from the BS. If the determination is still negative, it may omit further notifications to the BS until this status changes.

If the UE determines at step 410 that current time is available, it sends a notification toward the BS (step 435). Note that this notification may also be omitted if it does not represent a change to a previous status notification. In the embodiment of FIG. 4, when the UE receives a UTR (step 440), it calculates a value for T₂ (step 445). T₂ may be referred to as the non-delayed transmission time relative to T₁. Presuming the UTR indicates that it was sent from the BS at time T₀ and it is received at the UE at time T₁, then T₂=T₁+Tₚ, where Tₚ is the UE's internal processing time for a response to a transmission such as a UTR. Note that the UE is presumed to know this value, usually as a matter of manufacture and deployment rather than as calculated while in use. But the manner of acquiring Tₚ for this calculation is not a consideration in this embodiment.

In the embodiment of FIG. 4, The UE uses T₂ to calculate OTL=T₂−T₀. (step 450). As mentioned above, the OTL represents the time from a transmission by the BS to a ready response at the UE, including internal UE processing time. The UE then calculates a δOTL time (step 455), representing the amount of time in this embodiment that any responsive transmissions from the UE will be delayed before sending toward the BA. This may be expressed as δOTL=ROTL−OTL.

Where the UE is moving or the transmission path to the BS is changing, for example in the case of an intermediary AGP, this means that the OTL is changing and if rapid enough a significant impact on the transmission alignment could occur. For this reason, the process may take into account these changes. In the embodiment of FIG. 4, the UE is also configured to maintain an OTL history and estimate ΔOTL (step 460), the rate of OTL change for that UE.

Where ΔTOL is zero, as may be the case for a stationary device, or below a threshold as determined for individual implementations, the following steps may be omitted and transmissions times according to δOTL. In the embodiment of FIG. 4, it is presumed that the change is or may be significant and so the UE then calculates δOTL′, which represents the motion compensated transmission time adjustment. In this embodiment, this is calculated (step 465) as δOTL′=δOTL*(1+ΔTOL*Tₚ). Transmissions from the UE are then sent (step 470) as delayed by δOTL′, or in other words at T2+δOLT′.

The process then continues as additional transmissions are received and the various values are updated. Note that the sequences of operation illustrated in FIGS. 3 and 4 represent exemplary embodiments; some variation is possible within the spirit of the invention. For example, additional operations may be added to those shown in FIGS. 3 and 4, and in some implementations one or more of the illustrated operations may be omitted. For another example, the ROTL and the UTR need not be sent separately. In addition, the operations of the method may be performed in any logically-consistent order unless a definite sequence is recited in a particular embodiment.

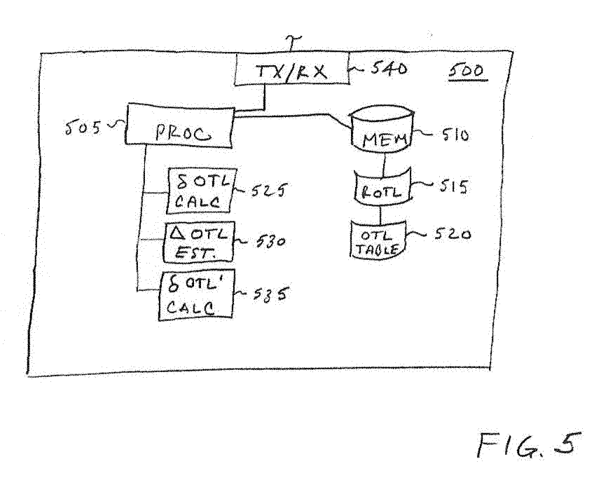

FIG. 5 is a simplified block diagram illustrating selected components of a UE 500. In this embodiment, UE 500 includes a processor 505 and a memory device 510. Processor 505 may be implemented in hardware or in software executing on a hardware device. Memory device 510 in this embodiment is a physical storage device that may in some cases operate according to stored program instructions. In any case, memory 510 is non-transitory in the sense of not being merely a propagating signal, unless explicitly recited otherwise in a particular embodiment. Memory 510 is used for storing, among other things, data as well as stored program instructions for execution by processor 505. Transceiver 540 for communicating with, inter alia, a serving base station is also depicted.

Shown separately in FIG. 5 is a memory storage register 515 for the current ROTL value and a table 520 for storing values of OTL. As mentioned above, a δOTL′ value may be computed by reference to historical OTL values (preferably associated with their time of calculation). A δOTL calculator 525 configured to calculate, in this embodiment, a non-delayed transmission time and an OTL for UE 500 as described above. A ΔTOL estimator 530 is configured to estimate a rate of change of the OTL from historical values. If the ΔTOL figure is determined to be significant, a δOTL′ calculator 535 calculates a δOTL′ value as a function of δOTL and ΔTOL.

Note that FIG. 5 illustrates selected components of an embodiment and some variations are described above. Other variations are possible without departing from the claims of the invention as there recited. In some of these embodiments, illustrated components may be integrated with each other or divided into subcomponents. There will often be additional components in the device management server and in some cases less. The illustrations components may also perform other functions in addition to those described above.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the sequence in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

What is claimed is:

1. A method for timing adjustment for a wireless communication network, comprising:
receiving in an UE (user equipment) an ROTL (reference one-way trip latency);
receiving in the UE an UTR (universal time reference);
calculating by the UE an OTL (one-way trip latency); and
calculating by the UE a transmission time adjustment.

2. The method according to claim 1, further comprising sending a transmission from the UE delayed by the calculated transmission time adjustment.

3. The method according to claim 1, wherein the ROTL and the UTR are received from a base station of the communication network.

4. The method according to claim 1, further comprising sending a common time availability status notification from the UE.

5. The method according to claim 4, further comprising receiving a transmission time adjustment.

6. The method according to claim 5, further comprising sending a transmission from the UE delayed by the received transmission time adjustment.

7. The method according to claim 1, further comprising maintaining a record of calculated OTL values.

8. The method according to claim 7, further comprising estimating a rate of change of OTL as a function of a plurality of OTL values.

9. The method according to claim 8, further comprising calculating a motion-compensated transmission time adjustment.

10. The method according to claim 1, wherein the OTL value comprises an internal processing time for the UE.

11. The method according to claim 1, further comprising determining an ROTL.

12. The method according to claim 11, further comprising broadcasting the ROTL.

13. The method according to claim 11, wherein determining the ROTL is executed in a base station of the communication network and comprises determining the maximum OTL for any UE currently within range of the base station.

14. The method according to claim 11, further comprising broadcasting a universal time reference.

15. The method according to claim 11, further comprising:
receiving at a base station of the communication network a notification that a UE does not have access to a common time value;
calculating by the base station a timing adjustment value for the UE; and
transmitting the time adjustment value.

16. A UE, comprising:
a processor;
a memory device accessible to the processor;
an OTL calculator configured to calculate an OTL for the UE;
a transmission time adjustment calculator configured to calculate a timing adjustment as a function of a received UTR, a received ROTL, and the calculated OTL.

17. The UE of claim 16, further comprising an OTL value table for recording calculated OTL values.

18. The UE of claim 17, further comprising an OTL rate of change estimator configured to estimate a rate of OTL change for the UE.

19. The UE of claim 18, further comprising a motion-compensated transmission time adjustment calculator configured to calculate a motion-compensated transmission time adjustment as a function of the timing adjustment and the estimated rate of OTL change.

20. A UE comprising:
a processor; and
a memory device, the memory device comprising program instructions that when executed by the processor cause the UE to:
calculate an OTL (one-way trip latency); and
calculate a transmission time adjustment.
